(19) United States
(12) Patent Application Publication
(10) Pub. No.: US 2013/0268480 A1
(43) Pub. Date: Oct. 10, 2013

(54) METHOD AND APPARATUS FOR SELECTIVE SUBFOLDER SYNCHRONIZATION IN A CLOUD-BASED ENVIRONMENT

(71) Applicant: BOX, INC., Los Altos, CA (US)

(72) Inventor: Griffin Dorman, San Francisco, CA (US)

(73) Assignee: BOX, INC., Los Altos, CA (US)

(21) Appl. No.: 13/856,607

(22) Filed: Apr. 4, 2013

Related U.S. Application Data
(60) Provisional application No. 61/620,568, filed on Apr. 5, 2012.

(51) Int. Cl. G06F 17/30

(52) U.S. Cl. CPC G06F 17/30575
USPC 707/608

(57) ABSTRACT

Techniques are disclosed for enabling selective subfolder synchronization in a cloud-based environment. In one embodiment, a method comprises, in response to a selection, from a user, of a first synchronization state of a first folder in a workspace, synchronizing content of the first folder associated with the user based on the first synchronization state regardless of a second synchronization state of a second folder in the workspace. The first folder is a subfolder of the second folder. The workspace is provided by a server of a cloud-based environment, and is shared among the user and one or more collaborators of the user. Among other advantages, embodiments disclosed herein provide fine-grained control to the users of a cloud collaboration environment over what folder(s) in their workspace is to be shared and/or synchronized.

### CROSS-REFERENCE TO RELATED APPLICATIONS AND EFFECTIVE FILING DATE ENTITLEMENT

This application is entitled to the benefit of and/or the right of priority to U.S. Provisional Application No. 61/620,568, entitled “SYNCHRONIZATION CLIENT SELECTIVE SUBFOLDER SYNCING IN A CLOUD-BASED ENVIRONMENT”(Attorney Docket No. 61599-8027.US00), filed Apr. 5, 2012, which is hereby incorporated by reference in its entirety. This application is therefore entitled to an effective filing date of Apr. 5, 2012.

### BACKGROUND

With the advancements in digital technologies, data proliferation and the ever increasing mobility of user platforms have created enormous amounts of information traffic over mobile and computer networks. This is particularly relevant with the increase of electronic and digital content being used in social settings or shared environments of digital content compared to traditional stand-alone personal computers and mobile devices. As a result, content is shared across multiple devices among multiple users.

However, to date, content sharing and content synchronization lacks an intuitive manner in which content or folders/files in a shared space among multiple users can be accessed and/or synchronized in a user friendly manner.

### BRIEF DESCRIPTION OF DRAWINGS

The present embodiments are illustrated by way of example and are not intended to be limited by the figures of the accompanying drawings. In the drawings:

FIG. 1 depicts an example diagram of a system having a host server of a cloud service, collaboration and/or cloud storage accounts with capabilities that enable selective subfolder synchronization in a cloud-based environment;

FIG. 2 depicts an example diagram of a web-based or online collaboration platform deployed in an enterprise or other organizational setting for organizing work items and workspaces;

FIG. 3A depicts an example diagram of a workspace in an online or web-based collaboration environment accessible by multiple collaborators through various devices;

FIG. 3B depicts an abstract diagram illustrating an example hierarchy of the folders in the workspace of FIG. 3A;

FIG. 3C depicts a table illustrating example synchronization states for moving a subfolder to a destination folder;

FIG. 4A depicts a flowchart illustrating an example process for a server selectively synchronizing one or more subfolders in a workspace with a client;

FIGS. 4B-4C respectively depict flowcharts illustrating further details of the process of FIG. 4A in accordance with some embodiments;

FIG. 5 depicts a flowchart illustrating an example process for a client selectively synchronizing one or more subfolders in a workspace with a server;

FIG. 6 depicts a flowchart illustrating an example process for a client selectively synchronizing one or more subfolders on the client with a server; and

FIG. 7 depicts a diagrammatic representation of a machine in the example form of a computer system within which a set of instructions, for causing the machine to perform any one or more of the methodologies discussed herein, can be executed.

The same reference numbers and any acronyms identify elements or acts with the same or similar structure or functionality throughout the drawings and specification for ease of understanding and convenience.

### DETAILED DESCRIPTION

Techniques are disclosed for enabling selective subfolder synchronization in a cloud-based environment. In one embodiment, a method comprises, in response to a selection, from a user, of a first synchronization state of a first folder in a workspace, synchronizing content of the first folder associated with the user based on the first synchronization state regardless of a second synchronization state of a second folder in the workspace. The first folder is a subfolder of the second folder. The workspace is provided by a server of a cloud-based environment, and is shared among the user and one or more collaborators of the user. In some embodiments, the method further comprises, in response to the selection, synchronizing content of other folders in the workspace based on their respective synchronization states. Among other advantages, embodiments disclosed herein provide fine-grained control to the users of a cloud collaboration environment over what folder(s) in their workspace is to be shared and/or synchronized, thereby reducing the amount of unnecessary and/or inappropriate information traffic over computer networks, especially in shared, collaborative environments.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others. Similarly, various requirements are described which can be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

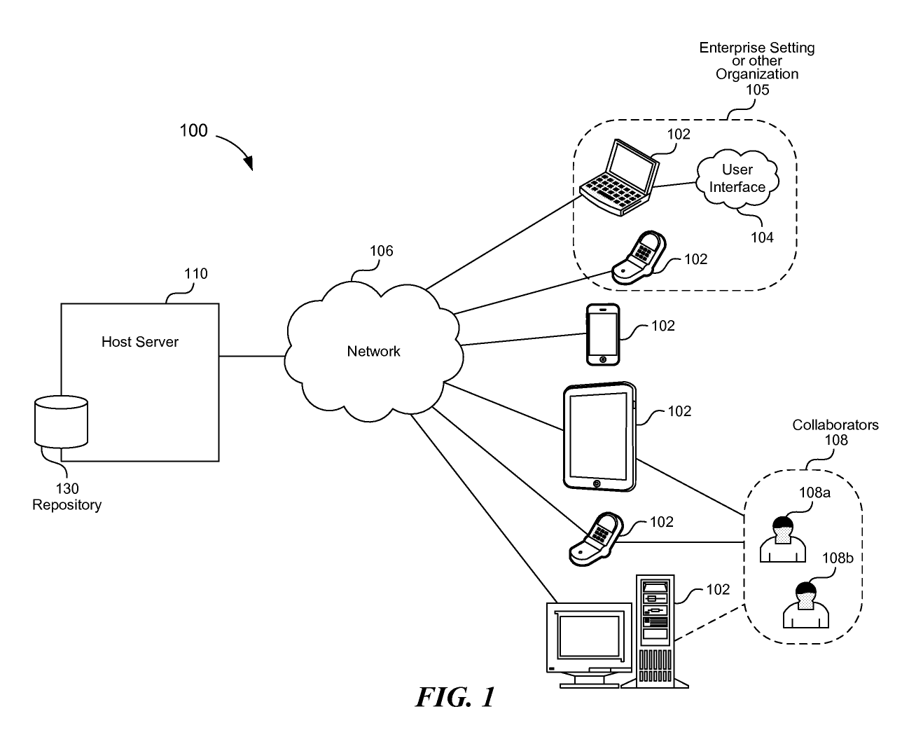

FIG. 1 illustrates an example diagram of a system 100 having a host server 110 of a cloud service/platform, collaboration and/or cloud storage service with capabilities that enable selective subfolder synchronization in a cloud-based environment.

The client devices 102 can be any system and/or device, and/or any combination of devices/systems that is able to establish a connection, including wired, wireless, cellular connections with another device, a server and/or other systems such as host server 110. Client devices 102 typically include a display and/or other output functionalities to present information and data exchanged between among the devices 102, and/or the host server 110.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a PDA, a smart phone (e.g., a BlackBerry device such as BlackBerry Z10/Q10, an iPhone, Nexus 4, etc.), a Treo, a handheld tablet (e.g. an iPad, iPad Mini, a Galaxy Note, Galaxy Note II, Xoom Tablet, Microsoft Surface, Blackberry PlayBook, Nexus 7, 10 etc.), a phablet (e.g., HTC Droid DNA, etc.), a tablet PC, a thin-client, a hand held console, a hand held gaming device or console (e.g., XBOX live, Nintendo DS, Sony PlayStation Portable, etc.), iOS powered watch, Google Glass, a Chromebook and/or any other portable, mobile, hand held devices, etc. running on any platform or any operating system (e.g., Mac-based OS (OS X, iOS, etc.), Windows-based OS (Windows Mobile, Windows 7, Windows 8, etc.), Android, Blackberry OS, Embedded Linux platforms, Palm OS, Symbian platform, Google Chrome OS, and the like. In one embodiment, the client devices 102, and host server 110 are coupled via a network 106. In some embodiments, the devices 102 and host server 110 can be directly connected to one another.

The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

Signals received or detected indicating user activity at client devices 102 through one or more of the above input mechanism, or others, can be used by various users or collaborators (e.g., collaborators 108) for accessing, through network 106, a web-based collaboration environment or online collaboration platform (e.g., hosted by the host server 110). The collaboration environment or platform can have one or more collective settings 105 for an enterprise or an organization that the users belong, and can provide an user interface 104 for the users to access such platform under the settings 105.

The collaboration platform or environment hosts workspaces with work items that one or more users can access (e.g., view, edit, update, revise, comment, download, preview, tag, or otherwise manipulate, etc.). A work item can generally include any type of digital or electronic content that can be viewed or accessed via an electronic device (e.g., device 102). The digital content can include .pdf files, .doc, slides (e.g., Powerpoint slides), images, audio files, multimedia content, web pages, blogs, etc. A workspace can generally refer to any grouping of a set of digital content in the collaboration platform. The grouping can be created, identified, or specified by a user or through other means. This user can be a creator user or administrative user, for example.

In general, a workspace can be associated with a set of users or collaborators (e.g., collaborators 108) which have access to the content included therein. The levels of access (e.g., based on permissions or rules) of each user or collaborator to access the content in a given workspace can be the same or can vary among the users. Each user can have their own set of access rights to every piece of content in the workspace, or each user can be different access rights to different pieces of content. Access rights can be specified by a user associated with a workspace and/or a user who created/uploaded a particular piece of content to the workspace, or any other designated user or collaborator.

In general, the collaboration platform allows multiple users or collaborators to access or collaborate efforts on work items such each user can see, remotely, edits, revisions, comments, or annotations being made to specific work items through their own user devices. For example, a user can upload a document to a workspace for other users to access (e.g., for viewing, editing, commenting, signing-off, or otherwise manipulating). The user can login to the online platform and upload the document (or any other type of work item) to an existing workspace or to a new workspace. The document can be shared with existing users or collaborators in a workspace.

In general, network 106, over which the client devices 102 and the host server 110 communicate can be a cellular network, a telephonic network, an open network, such as the Internet, or a private network, such as an intranet and/or the extranet, or any combination or variation thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102 and the host server 110 and can appear as one or more networks to the serviced systems and devices. In one embodiment, communications to and from the client devices 102 can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The embodiments disclosed herein recognize that, with the growing prevalence of the communication networks (e.g., the Internet) and smart portable devices (e.g., smart phones), there are many instances when a user want to selectively share one or more subfolders in a workspace that is associated with the user, and especially when the workspace is shared among one or more collaborators of the user. Also, the user can have more than one user devices that are capable of connecting to the workspace, and sometimes not all data in the workspace are desirable or necessary to be shared to all devices because of nature of data (e.g., confidentiality, sensitivity, and/or necessity), physical constraints of a particular device (e.g., screen size, computing power, or storage and/or network limitations), or for other applicable reasons.

Accordingly, embodiments of the present disclosure provide systems and methods that enable selective subfolder synchronization in a cloud-based environment/platform/services (e.g., collaboration, file sharing, and/or storage services) so that a user of the cloud-based environment can select individual folders for synchronizing according to his/her own preference. The advantages provided by the techniques disclosed herein are particularly beneficial when a large number of files are stored in the workspace.

In accordance with some embodiments, the host server 110 can selectively synchronize one or more subfolders in the workspace with a synchronization client (e.g., on the client device 102). Specifically, the host server 110 can synchronize, in response to a selection of a first synchronization state of a first folder in the workspace from a user (e.g., of a client device 102), content of a first folder associated with the user based on the first synchronization state regardless of a second synchronization state of a second folder in the workspace. The first folder is a subfolder of the second folder. For example, the host server 110 can selectively synchronize a folder and block synchronization for one or more subfolders within the synchronized folder. For purposes of discussion herein, a workspace of a cloud-based environment, which is hosted by the host server 110, is shared among the user and one or more collaborators of the user.

In one embodiment, the host server 110 also communicates relevant details to the synchronization client on the client devices 102 for selective synchronization, and the synchronization client can selectively synchronize one or more subfolders in the workspace with the host server 110. Specifically, in some embodiments, the synchronization client can receive from the host server 110 the user's selection for the first synchronization state of the first folder in the workspace. In response to the received selection, the synchronization client synchronizes content of the first folder associated with the user based on the first synchronization state regardless of a second synchronization state of a second folder in the workspace.

Further, in some embodiments, the user can select a folder that is stored on the client to be synchronized with the host server 110. The synchronization client can receive, at the synchronization client on the client device 102, the user's selection of a synchronization state of a folder on the client. In response to the selection, the synchronization client synchronizes content of the folder on the client with the workspace based on the selected synchronization state regardless of another synchronization state of another folder. The folder is a subfolder of the another folder.

More implementation details on the host server 110, the synchronization client, the workspace, the files and folders stored therein, and the relationship between the user and the collaborators are discussed below.

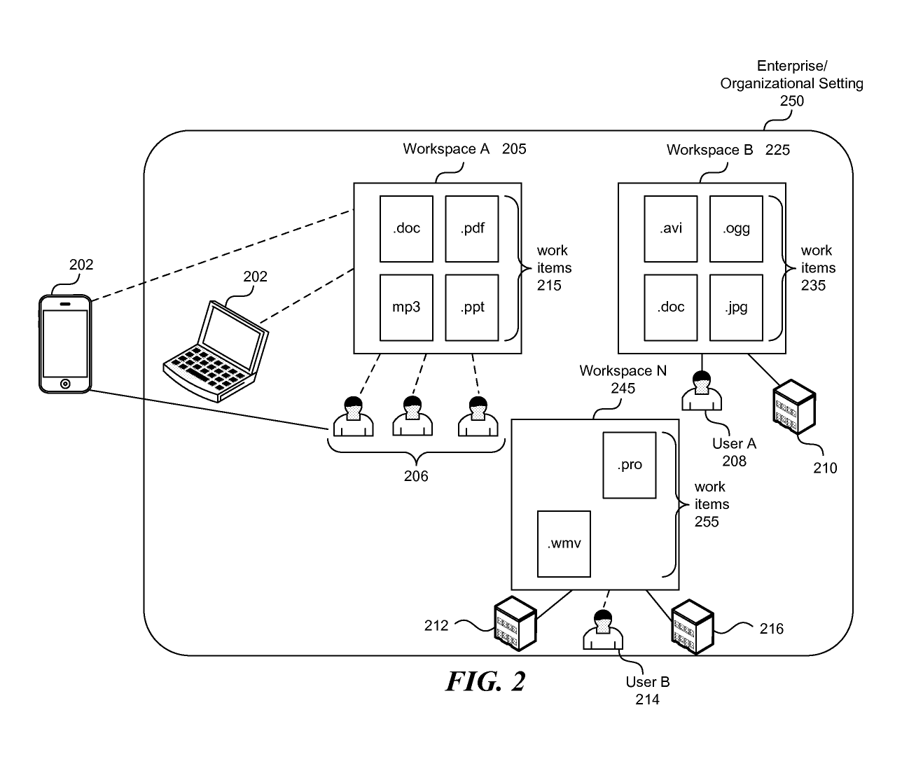

FIG. 2 depicts an example diagram of a web-based or online collaboration platform deployed in an enterprise or other organizational setting 250 for organizing work items 215, 235, 255 and workspaces 205, 225, 245.

The web-based platform for collaborating on projects or jointly working on documents can be used by individual users and shared among collaborators. In addition, the collaboration platform can be deployed in an organized setting including but not limited to, a company (e.g., an enterprise setting), a department in a company, an academic institution, a department in an academic institution, a class or course setting, or any other types of organizations or organized setting.

When deployed in an organizational setting, multiple workspaces (e.g., workspace A, B C) can be created to support different projects or a variety of work flows. Each workspace can have its own associate work items. For example, workspace A 205 can be associated with work items 215, workspace B 225 can be associated with work items 235, and workspace N can be associated with work items 255. The work items 215, 235, and 255 can be unique to each workspace but need not be. For example, a particular word document can be associated with only one workspace (e.g., workspace A 205) or it can be associated with multiple workspaces (e.g., Workspace A 205 and workspace B 225, etc.).

In general, each workspace has a set of users or collaborators associated with it. For example, workspace A 205 is associated with multiple users or collaborators 206. In some instances, workspaces deployed in an enterprise can be department specific. For example, workspace B can be associated with department 210 and some users shown as example user A 208 and workspace N 245 can be associated with departments 212 and 216 and users shown as example user B 214.

Each user associated with a workspace can generally access the work items associated with the workspace. The level of access will depend on permissions associated with the specific workspace, and/or with a specific work item. Permissions can be set for the workspace or set individually on a per work item basis. For example, the creator of a workspace (e.g., one of user A 208 who creates workspace B) can set one permission setting applicable to all work items 235 for other associated users and/or users associated with the affiliate department 210, for example. Creator user A 208 can also set different permission settings for each work item, which can be the same for different users, or varying for different users.

In each workspace A, B . . . N, when an action is performed on a work item by a given user or any other activity is detected in the workspace, other users in the same workspace can be notified (e.g., in real time or in near real time, or not in real time). Activities which trigger real time notifications can include, by way of example but not limitation, adding, deleting, or modifying collaborators in the workspace, uploading, downloading, adding, deleting a work item in the workspace, creating a discussion topic in the workspace.

In some embodiments, items or content downloaded or edited can cause notifications to be generated. Such notifications can be sent to relevant users to notify them of actions surrounding a download, an edit, a change, a modification, a new file, a conflicting version, an upload of an edited or modified file.

In one embodiment, in a user interface to the web-based collaboration platform where notifications are presented, users can, via the same interface, create action items (e.g., tasks) and delegate the action items to other users including collaborators pertaining to a work item 215, for example. The collaborators 206 can be in the same workspace A 205 or the user can include a newly invited collaborator. Similarly, in the same user interface where discussion topics can be created in a workspace (e.g., workspace A, B or N, etc.), actionable events on work items can be created and/or delegated/assigned to other users such as collaborators of a given workspace 206 or other users. Through the same user interface, task status and updates from multiple users or collaborators can be indicated and reflected. In some instances, the users can perform the tasks (e.g., review or approve or reject, etc.) via the same user interface.

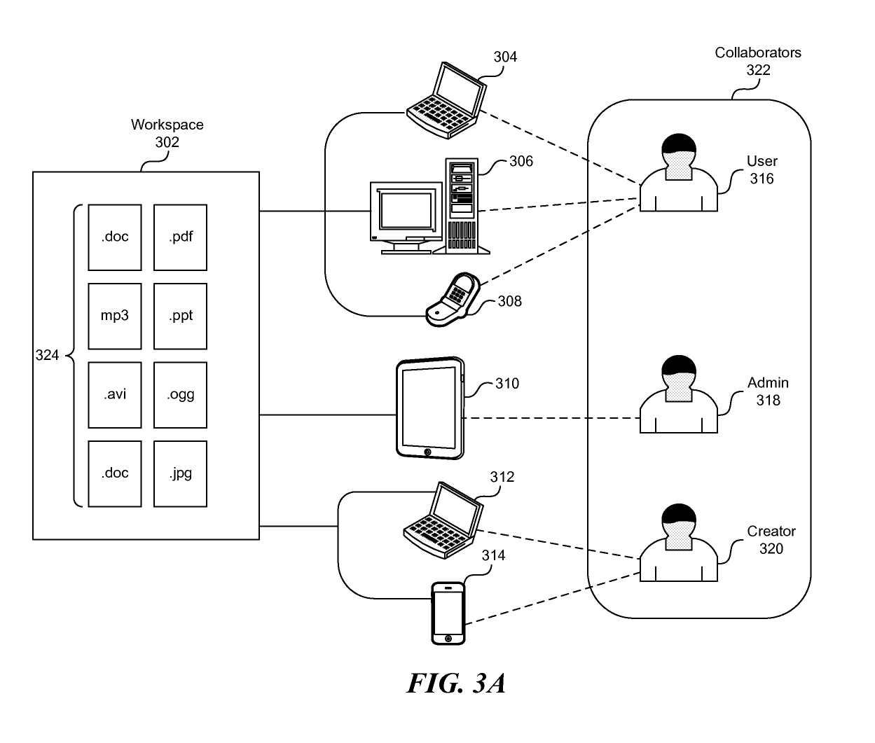

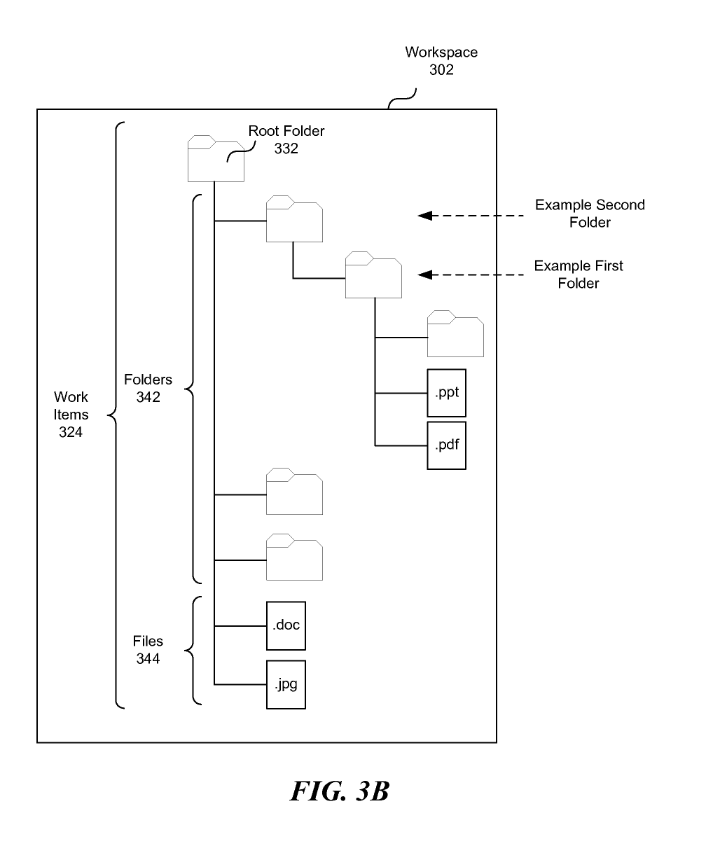

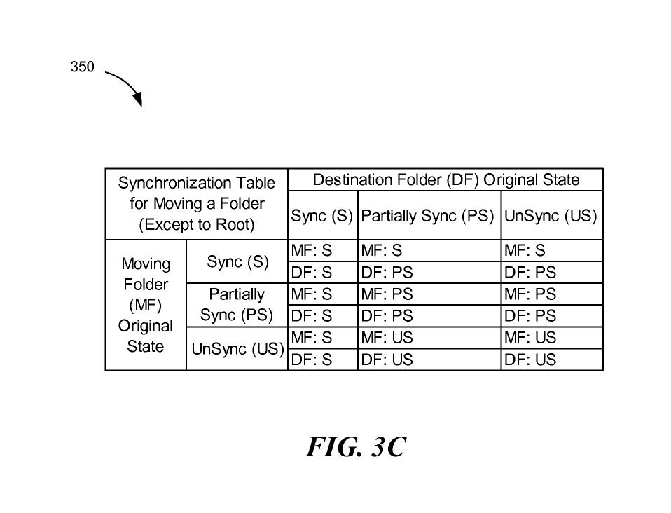

FIG. 3A depicts an example diagram of a workspace 302 in an online or web-based collaboration environment accessible by multiple collaborators 322 through various devices.

Each of users 316, 318, and 320 can individually use multiple different devices to access and/or manipulate work items 324 in the workspace 302 with which they are associated with. For example users 316, 318, 320 can be collaborators on a project to which work items 324 are relevant. Since the work items 324 are hosted by the collaboration environment (e.g., a cloud-based environment), each user can access the work items 324 anytime, and from any physical location using any device (e.g., including devices they own or any shared/public/loaner device).

Work items to be edited or viewed can be accessed from the workspace 302. Users can also be notified of access, edit, modification, and/or upload related-actions performed on work items 324 by other users or any other types of activities detected in the workspace 302. For example, if user 316 modifies a document, one or both of the other collaborators 318 and 320 can be notified of the modification in real time, or near real-time, or not in real time. The notifications can be sent through any of all of the devices associated with a given user, in various formats including, one or more of, email, SMS, or via a pop-up window in a user interface in which the user uses to access the collaboration platform. In the event of multiple notifications, each notification can be depicted preferentially (e.g., ordering in the user interface) based on user preferences and/or relevance to the user (e.g., implicit or explicit).

For example, a notification of a download, access, read, write, edit, or uploaded related activities can be presented in a feed stream among other notifications through a user interface on the user device according to relevancy to the user determined based on current or recent activity of the user in the web-based collaboration environment.

In one embodiment, the notification feed stream further enables users to create or generate actionable events (e.g., as task) which are or can be performed by other users 316 or collaborators 322 (e.g., including admin users or other users not in the same workspace), either in the same workspace 302 or in some other workspace. The actionable events such as tasks can also be assigned or delegated to other users via the same user interface.

For example, a given notification regarding a work item 324 can be associated with user interface features allowing a user 316 to assign a task related to the work item 324 (e.g., to another user 316, admin user 318, creator user 320 or another user). In one embodiment, a commenting user interface or a comment action associated with a notification can be used in conjunction with user interface features to enable task assignment, delegation, and/or management of the relevant work item or work items in the relevant workspaces, in the same user interface.

FIG. 3B depicts an abstract diagram illustrating an example hierarchy of the folders in the workspace 302 of FIG. 3A. The techniques disclosed herein are now discussed with simultaneous reference to FIGS. 1 and 3A-3B.

Work items 324 of FIG. 3A can be further organized into groups using one or more folders 342 within workspace 302. The folders 342 can have more than one levels of hierarchy including, for example, parent/ascendant folder(s), child/decedent folder(s) or subfolder(s), and/or sibling folder(s). A person having ordinary skill in the art will understand that terminologies describing the hierarchy of the folders are used in a relative sense. For example, a parent folder can be a child folder of a grandparent folder, a particular child folder can be a parent folder of a grandchild folder, and so on. An example of first and second folders is illustrated on FIG. 3B, where the first folder is a subfolder of the second folder. It is noted that the illustration of the two folders are merely exemplary; depending on the embodiments, there can be more than one level of hierarchy (e.g., the first folder is a grandchild folder of the second folder) between the first and the second folders, and that the second folder can be the root folder 332.

In accordance with some embodiments, the host server 110 provides the capability of selectively synchronizing an individual subfolder (e.g., a first folder in folders 342) in addition to synchronizing everything that is included in the entire the root folder 332. Additionally, the host server 110 can selectively block the first folder from being synchronized, even when the first folder is within a parent folder (e.g., a second folder) that is synchronized. More specifically, the host server 110 can synchronize, in response to a selection of a first synchronization state of the first folder in the workspace 302, content of the first folder associated with the user based on the first synchronization state regardless of a second synchronization state of a second folder in the workspace 302, even if the first folder is a subfolder of the second folder. The user's selection can be received from the user via the user interface 104 (e.g., in forms of webpages) of the host server 110, via a synchronization client running on the client devices 102, or via any other suitable sources. In some embodiments, the host server 110 synchronizes, in response to the selection, content of other folders in the workspace 302 based on their respective synchronization states. For purposes of discussion herein, “content” of a respective folder (e.g., a root folder 332 of the workspace 302) refers to files (e.g., files 344) stored in the respective folder. According to some embodiments, all the files 344 or content in the respective folder have same synchronization states as the respective folder, and subfolders (e.g., folders 342) within the respective folder each has its independent synchronization state.

In some embodiments, the host server 110 determines the first synchronization state of the first folder before the host server 110 synchronizes the first folder with the synchronization client(s). The first synchronization state can include one or more of: (i) synchronized, (ii) partially synchronized, or (iii) unsynchronized. Specifically, in one or more embodiments, the host server 110 assigns the first synchronization state as synchronized if the content of the first folder and all its subfolders are all synchronized. The host server 110 can assign the first synchronization state as unsynchronized if the content of the first folder and the subfolders are all unsynchronized, and can further assign the first synchronization state as partially synchronized if the content of the first folder and the subfolders are neither all synchronized nor all unsynchronized.

One or more embodiments provide that the host server 110 allows (e.g., by providing options or checkboxes to the user via the user interface 104) the user to select the first synchronization state based on an original synchronization state of the first folder. For example, if the original synchronization state is synchronized, then the host server 110 allows the user to disable the first synchronization state to unsynchronized. If the original synchronization state is partially synchronized, then the host server 110 allows the user to either enable the first synchronization state to synchronized or to disable the first synchronization state to unsynchronized. If the original synchronization state is unsynchronized, then the host server 110 allows the user to enable the first synchronization state to synchronized.

Further, after receiving the user's selection, the host server 110 can automatically assign synchronization states to the first folder and/or other folders in workspace 302 based on the user's selection. Specifically, in some embodiments, if the user enables the first synchronization state, then the host server 110 assigns synchronization states of all subfolders of the first folder as synchronized. If the user disables the first synchronization state, then the host server 110 assigns synchronization states of all subfolders of the first folder as unsynchronized.

Additionally, in response to the user's selection, the host server 110 can automatically update the synchronization state of the second folder, of which the first folder is a subfolder. For example, if all subfolders of the second folder are synchronized, then the host server 110 assigns the second synchronization state as synchronized. If all subfolders of the second folder are unsynchronized, then the host server 110 assigns the second synchronization state as unsynchronized. In response to the selection, if not all subfolders of the second folder are all synchronized or all unsynchronized, then the host server 110 assigns the second synchronization state as partially synchronized. In some embodiments, the update is recursively performed by the server 110 to all folders related to the first folder, including ascendant and/or decedent folders.

In accordance with some embodiments disclosed herein, the user can select to create the first folder in the workspace 302 if it does not exist. When the first folder is created, the host server 302 can automatically assign the first synchronization state to the first folder based on the second folder's synchronization. If the second synchronization state is synchronized, then the host server 110 assigns the first synchronization state as synchronized. If the second synchronization state is not synchronized (e.g., unsynchronized or partially synchronized), then the host server 110 assigns the first synchronization state as unsynchronized. It is noted that, in some embodiments, the server 110's operations of copying a folder is similar to that of creating a folder. Specifically, the original first synchronization state is ignored by the host server 110, and the host server 110 assigns a new synchronization state to the newly created folder based on the synchronization state of the parent folder of the newly created folder.

In another additional or alternative embodiment, the user can select to move the first folder (e.g., a moving folder) in the workspace 302 into another folder (e.g., a destination folder) in the workspace 302. The another folder can be any folder in the workspace 302 including the folders 342 and the root folder 332. According to some implementations, upon moving, the host server 110 can update the first synchronization state based on the synchronization state of the another folder. In one embodiment, the host server 110 assigns the first synchronization state as synchronized if the synchronization state of the another folder is synchronized. In addition, the host server 110 maintains the first synchronization state as is if the third synchronization state is not synchronized (e.g., unsynchronized or partially synchronized).

In yet another embodiment, if the synchronization state of another folder originally is unsynchronized, and if the first synchronization state originally is not unsynchronized, the host server 110 assigns the synchronization state of another folder as partially synchronized. If the another folder is the root directory 332 of the workspace 302, the host server can 110 maintain the first synchronization state as is. A table 350 which illustrates example synchronization states for moving the first folder to the destination folder is depicted in FIG. 3C.

According to some embodiments, all files or content (e.g., files 344) in the root directory 332 of the workspace 302 have synchronization states as synchronized, and the synchronization state of the root directory 332 is permanently set as partially synchronized.

Moreover, the host server 110 can display, on the user interface 102 of the server, an icon for a respective folder that distinctively indicates a synchronization state of the respective folder. For example, the host server 110 can use a first image for the state of the respective folder being synchronized, another image for the state of the respective folder being partially synchronized, and yet another image for the state of the respective folder being unsynchronized.

As previously mentioned, the host server 110 synchronizes the content of the first folder in the workspace 302 with a synchronization client on client devices 102; the term “synchronization client” can refer to software, hardware, firmware, or any suitable combination thereof that can communicate with the host server 110 in performing the synchronization. Accordingly, in some embodiments, the client (e.g., client devices 102) can receive from the host server 110 a selection from the user for the first synchronization state of the first folder in the workspace 302, and, in response to the received selection, the client synchronizes content of the first folder associated with the user based on the first synchronization state regardless of a second synchronization state of a second folder in the workspace 302. In response to the received selection, the client can additionally synchronize content of other folders in the workspace 302 with data stored on the client based on their respective synchronization states.

The synchronization client can further maintain, on the client, a directory tree that corresponds to a directory structure of the first folder. The directory tree on the client includes all folders having a higher hierarchy above the first folder. For example, if there is a folder named “Alpha” under the root folder 332 in the workspace 302, and inside that “Alpha” folder is a subfolder named “Beta.” Even if the user only enables the synchronization state for “Beta” but not for “Alpha,” then the directory structure of the Beta folder on the client can still be maintained as “Root/Alpha/Beta.”

Furthermore, in some embodiments, if the user enables the first synchronization state and if a local folder that corresponds to the first folder in the workspace 302 does not exist on the client, the client can create the local folder on the client. Also, if (i) the user enables the first synchronization state and if the first folder is deleted in the workspace 302, or if (ii) the user disables the first synchronization state of the first folder, the client can delete the local folder that corresponds to the first folder from the local drive. For example, if a folder in the workspace 302 is disabled by the user from synchronization, the folder is to be removed locally, either immediately or at an appropriate time (e.g., when a next synchronization iteration is performed). Similarly, if a folder in the workspace 302 is enabled by the user for synchronization, it is to be added locally, either immediately or at an appropriate time (e.g., when the next synchronization iteration is performed).

Additionally or alternatively, the user can use the synchronization client to selectively synchronize one or more subfolders on the client with the host server 110. More precisely, the client can receive, at the client (e.g., client devices 102), a selection from the user for a synchronization state of a folder on the client, and in response to the selection, the client synchronizes content of the folder on the client with the workspace 302 based on the synchronization state of the folder regardless of a synchronization state of another folder. In some embodiments, the folder is a subfolder of the another folder. In response to the selection, the client can further synchronize content of other folders on the client with the workspace 302 based on their respective synchronization states.

Also, one or more embodiments provide that the client maintains a directory tree in the workspace 302 that corresponds to a directory structure of the folder on the client. Similar to a manner described above, the directory tree in the workspace can include all ascendant folders having a higher hierarchy above the folder on the client. Specifically, the client communicates to the host server 110 relevant information for the server 110 to perform actions suitable to synchronize, in the workspace 302, the content and the directory structure of the first folder.

For instance, if the user enables the synchronization state of the folder on the client and if the folder is deleted, the client can communicate to the host server 110 to delete a folder in the workspace 302 that corresponds to the first folder on the client.

For another instance, the client may, in response to the user creating the first folder, if a folder that corresponds to the first folder does not exist in the workspace 302, then the client requests the host server 110 to create the folder that corresponds to the first folder in the workspace 302 for synchronization. On the other hand, if the folder that corresponds to the first folder already exists in the workspace 302, then the client requests the host server 110 to create a conflicting folder in the workspace 302 for synchronization. In this way, risk of accidental overwriting data can be minimized.

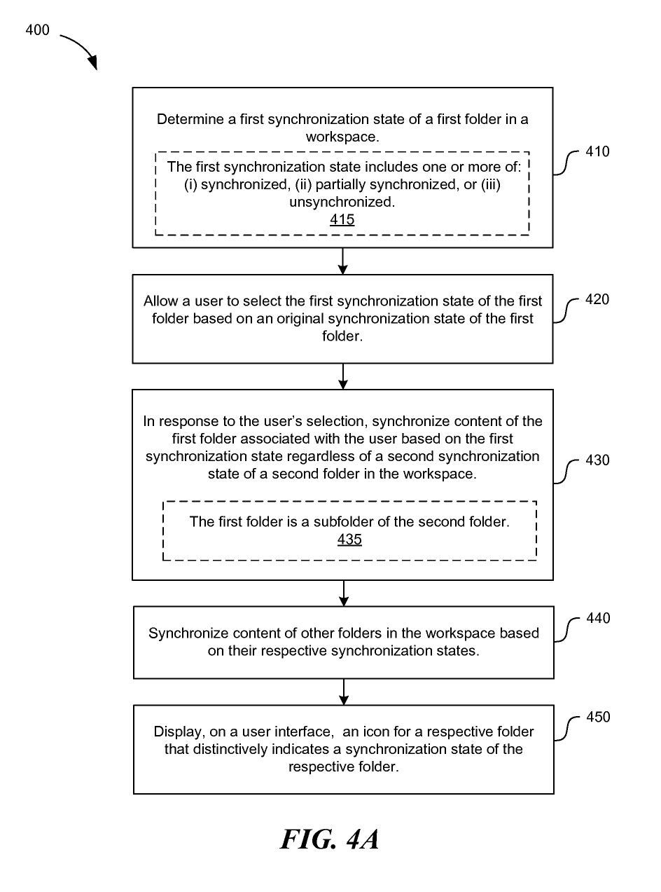

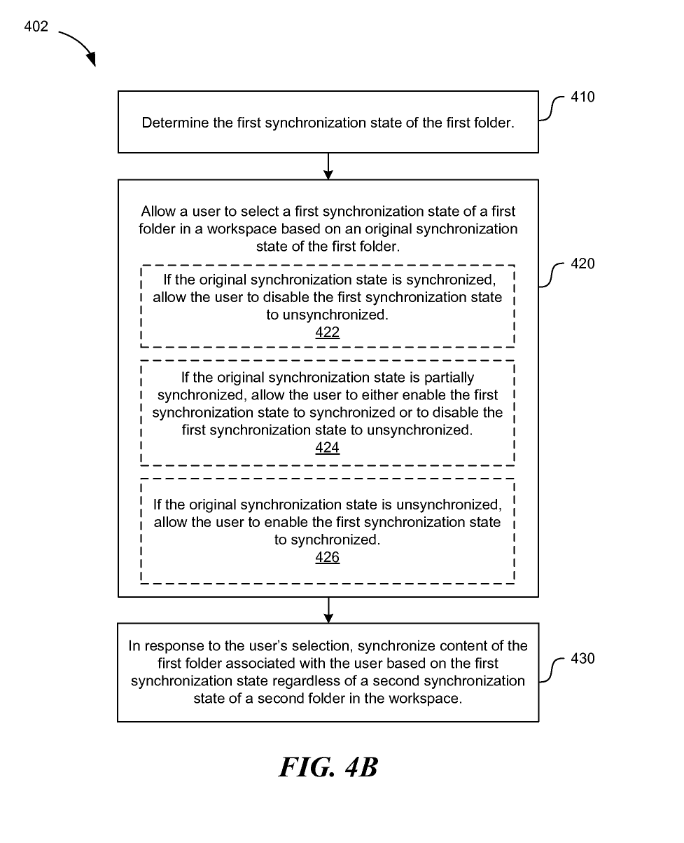

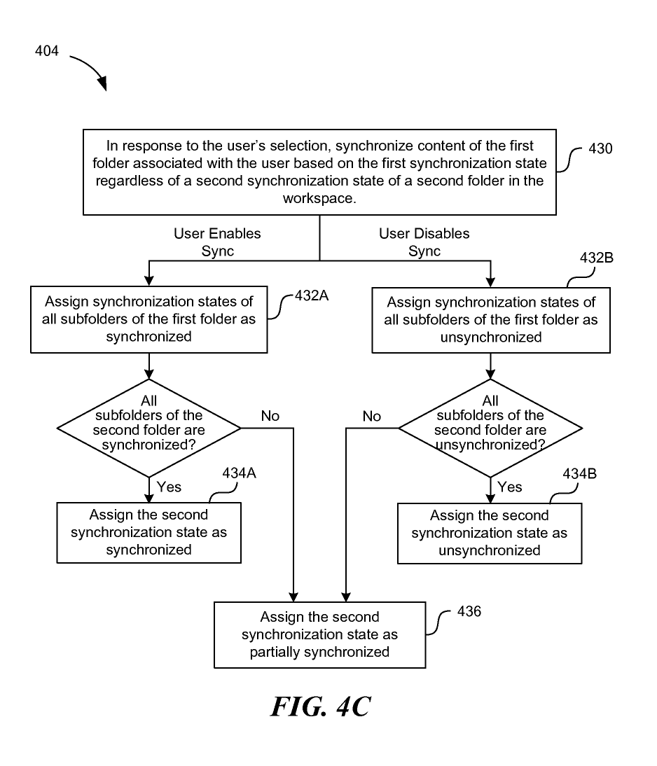

FIG. 4A depicts a flowchart illustrating an example process 400 for a server (e.g., the host server 110, FIG. 1) selectively synchronizing one or more subfolders in a workspace (e.g., workspace 302, FIGS. 3A-3B) of a cloud-based environment with a client (e.g., on client devices 102, FIG. 1). The process 400 is performed, for example, by a processor that is included on the server 110. Workspace 302 (e.g., workspaces A 205, B 225, or N 245, FIG. 2) is shared among a user of the client devices 102 and one or more collaborators (e.g., collaborators 108, FIG. 1) of the user. The host server 110 is a server that hosts the cloud-based environment.

According to one or more embodiments, the host server 110 determines (410) a first synchronization state of a first folder (e.g., one of folders 342, FIG. 3B). The first synchronization state can include (415) one or more of: (i) synchronized, (ii) partially synchronized, or (iii) unsynchronized. Then, the host server 110 allows (420) the user to select the first synchronization state of the first folder based on an original synchronization state of the first folder. For example, if the first folder is originally synchronized, then the user can disable the first synchronization state to unsynchronized. If the first folder is originally unsynchronized, then the user can enable the first synchronization state to synchronized. If the first folder is originally partially synchronized, then the user can either enable or disable the first synchronization state.

Thereafter, in response to the user's selection, the host server 110 synchronizes (430) content of the first folder associated with the user based on the first synchronization state regardless of a second synchronization state of a second folder in the workspace 302. In some embodiments, the first folder is (435) a subfolder of the second folder. Additionally, the host server 110 synchronizes (440) content of other folders in the workspace 302 based on their respective synchronization states.

Furthermore, in one or more embodiments, the host server 110 displays (450) on a user interface (e.g., user interface 104), an icon for a respective folder that distinctively indicates a synchronization state of the respective folder. For example, the host server 110 can use a first image for the state of the respective folder being synchronized, another image for the state of the respective folder being partially synchronized, and yet another image for the state of the respective folder being unsynchronized.

FIGS. 4B-4C respectively depict flowcharts illustrating further details of the process of FIG. 4A in accordance with some embodiments. In FIG. 4B, the operations 410 and 430 are performed as described for the process 400 (FIG. 4A). After operation 410, if the original synchronization state is synchronized, then the host server 110 allows (422) the user to disable the first synchronization state to unsynchronized. If the original synchronization state is partially synchronized, then the host server 110 allows (424) the user to either enable the first synchronization state to synchronized or to disable the first synchronization state to unsynchronized. If the original synchronization state is unsynchronized, then the host server 110 allows (426) the user to enable the first synchronization state to synchronized.

In FIG. 4C, the operations 430 are performed as described for the process 400 (FIG. 4A). Additionally, in some embodiments, if the user enables the first synchronization state, then the host server 110 assigns (432A) synchronization states of all subfolders of the first folder as synchronized. If the user disables the first synchronization state, then the host server 110 assigns (432B) synchronization states of all subfolders of the first folder as unsynchronized.

Further, in response to the user's selection, the host server 110 can automatically update the synchronization state of the second folder, of which the first folder is a subfolder. For example, if all subfolders of the second folder are synchronized, then the host server 110 assigns (434A) the second synchronization state as synchronized. If all subfolders of the second folder are unsynchronized, then the host server 110 assigns (434B) the second synchronization state as unsynchronized. In response to the selection, if not all subfolders of the second folder are all synchronized or all unsynchronized, then the host server 110 assigns (436) the second synchronization state as partially synchronized. In some embodiments, the update is recursively performed by the server 110 to all folders related to the first folder, including ascendant and/or decedent folders.

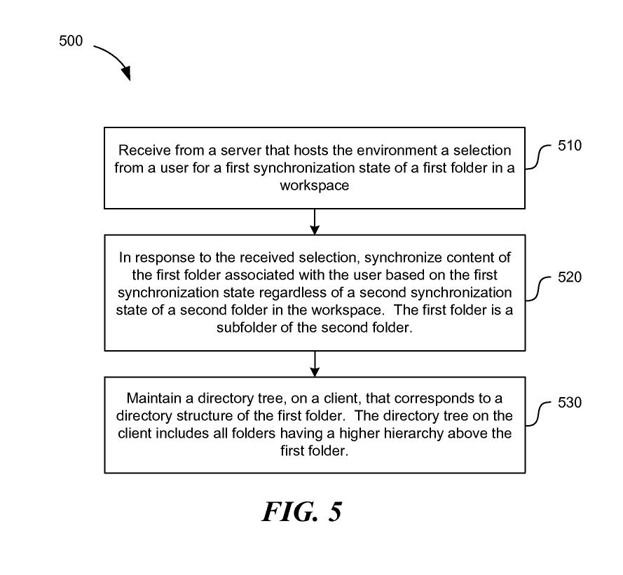

FIG. 5 depicts a flowchart illustrating an example process 500 for a client (e.g., client devices 102, FIG. 1) selectively synchronizing one or more subfolders in a workspace (e.g., workspace 302, FIGS. 3A-3B) with a server (e.g., host server 110, FIG. 1). The process 500 is performed, for example, by a processor (not shown for simplicity) that is included on the client device 102. Workspace 302 (e.g., workspaces A 205, B 225, or N 245, FIG. 2) is shared among a user of the client devices 102 and one or more collaborators (e.g., collaborators 108, FIG. 1) of the user. The host server 110 is a server that hosts the cloud-based environment.

According to one or more embodiments, the client devices 102 can receive (510) from the host server 110 a selection from the user for the first synchronization state of the first folder in the workspace 302, and, in response to the received selection, the client devices 102 synchronize (520) content of the first folder associated with the user based on the first synchronization state regardless of a second synchronization state of a second folder in the workspace 302. In response to the received selection, the client devices 102 can additionally synchronize content of other folders in the workspace 302 with data stored on the client devices 102 based on their respective synchronization states.

The client devices 102 can further maintain (530), on the client devices 102, a directory tree that corresponds to a directory structure of the first folder. In some embodiments, the directory tree on the client devices 102 includes all folders having a higher hierarchy above the first folder.

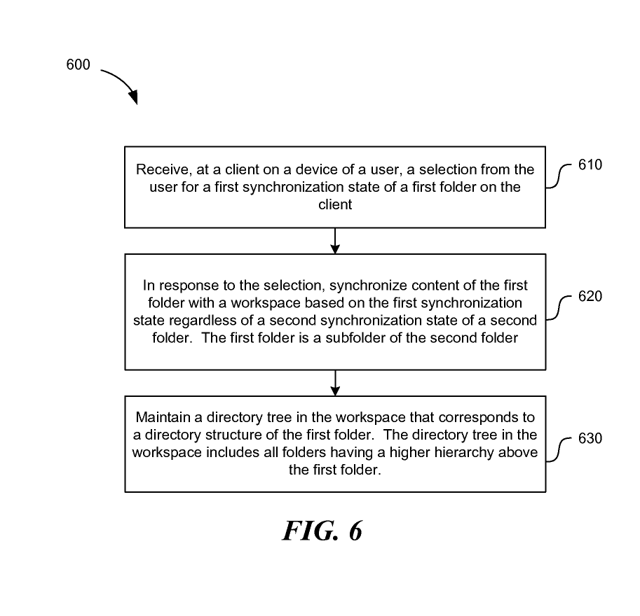

FIG. 6 depicts a flowchart illustrating an example process 600 for a client (e.g., client devices 102, FIG. 1) selectively synchronizing one or more subfolders on the client with a server (e.g., host server 110, FIG. 1). The process 600 is performed, for example, by a processor (not shown for simplicity) that is included on the client device 102. Workspace 302 (e.g., workspaces A 205, B 225, or N 245, FIG. 2) is shared among a user of the client devices 102 and one or more collaborators (e.g., collaborators 108, FIG. 1) of the user. The host server 110 is a server that hosts the cloud-based environment.

According to one or more embodiments, the client devices 102 can receive (610), at the client devices 102, a selection from the user for a synchronization state of a folder on the client device 102, and in response to the selection, the client devices 102 synchronize (620) content of the folder on the client devices 102 with the workspace 302 based on the synchronization state of the folder regardless of a synchronization state of another folder. In some embodiments, the folder is a subfolder of the another folder. In some embodiments, in response to the selection, the client device 102 can further synchronize content of other folders on the client device 102 with the workspace 302 based on their respective synchronization states.

Also, one or more embodiments provide that the client devices 102 maintain (630) a directory tree in the workspace 302 that corresponds to a directory structure of the folder on the client device 102. The directory tree in the workspace can include all ascendant folders having a higher hierarchy above the folder on the client devices 102. Specifically, the client devices 102 can communicate to the host server 110 relevant information for the server 110 to perform actions suitable to synchronize, in the workspace 302, the content and the directory structure of the first folder.

In one implementation, if the user enables the synchronization state of the folder on the client devices 102 and if the folder is deleted, the client devices 102 can communicate to the host server 110 to delete a folder in the workspace 302 that corresponds to the first folder on the client devices 102.

For an additional or alternative implementation, the client device 102 may, in response to the user creating the first folder, if a folder that corresponds to the first folder does not exist in the workspace 302, then the client devices 102 request the host server 110 to create the folder that corresponds to the first folder in the workspace 302 for synchronization. On the other hand, if the folder that corresponds to the first folder already exists in the workspace 302, then the client requests the host server 110 to create a conflicting folder in the workspace 302 for synchronization. In this way, risk of accidental overwriting data can be minimized.

Overall, the techniques disclosed herein provide fine-grained control to the users of a cloud collaboration environment over what folder(s) in their workspace is to be shared and/or synchronized, thereby reducing the amount of unnecessary and/or inappropriate information traffic over computer networks, especially in shared, collaborative environments.

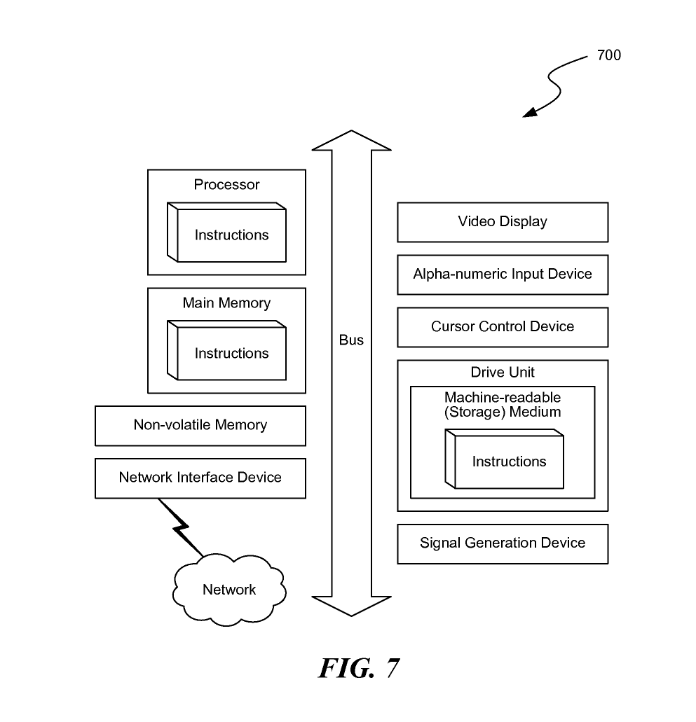

FIG. 7 shows a diagrammatic representation 700 of a machine in the example form of a computer system within which a set of instructions, for causing the machine to perform any one or more of the methodologies discussed herein, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a user device, a tablet, a phablet, a laptop computer, a set-top box (STB), a personal digital assistant (PDA), a thin-client device, a cellular telephone, an iPhone, an iPad, aBlackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 2800 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments can perform routines having steps, or employ systems having blocks, in a different order, and some processes or blocks can be deleted, moved, added, subdivided, combined, and/or modified to provide alternative or subcombinations. Each of these processes or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that can be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system can vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects can likewise be embodied as a means-plus-function claim, or in other forms, such as being embodied in a computer-readable medium. (Any claim intended to be treated under 35 U.S.C. §112, ¶6 begins with the words “means for”.) Accordingly, the applicant reserves the right to add additional claims after filing the application to pursue such additional claim forms for other aspects of the disclosure.

What is claimed is:

1. A method for synchronizing folders in a workspace of a cloud-based environment, the method comprising:
in response to a selection, from a user, of a first synchronization state of a first folder in the workspace, synchronizing content of the first folder associated with the user based on the first synchronization state regardless of a second synchronization state of a second folder in the workspace,
wherein, the first folder is a subfolder of the second folder, and
wherein, the workspace is shared among the user and one or more collaborators of the user.

2. The method of claim 1, further comprising:
in response to the selection, synchronizing content of other folders in the workspace based on their respective synchronization states.

3. The method of claim 1, further comprising:
before the synchronizing, determining the first synchronization state of the first folder, wherein the first synchronization state includes one or more of: (i) synchronized, (ii) partially synchronized, or (iii) unsynchronized.

4. The method of claim 3, further comprising:
allowing the user to select the first synchronization state based on an original synchronization state of the first folder.

5. The method of claim 4, wherein the allowing comprises:
if the original synchronization state is synchronized, allowing the user to disable the first synchronization state to unsynchronized.

6. The method of claim 5, wherein the allowing further comprises:
if the original synchronization state is partially synchronized, allowing the user to either enable the first synchronization state to synchronized or to disable the first synchronization state to unsynchronized.

7. The method of claim 6, wherein the allowing further comprises:
if the original synchronization state is unsynchronized, allowing the user to enable the first synchronization state to synchronized.

8. The method of claim 3, wherein the determining comprises:
assigning the first synchronization state as synchronized if the content of the first folder and all subfolders of the first folder are all synchronized.

9. The method of claim 8, wherein the determining further comprises:
assigning the first synchronization state as unsynchronized if the content of the first folder and the subfolders are all unsynchronized.

10. The method of claim 9, wherein the determining further comprises:
assigning the first synchronization state as partially synchronized if the content of the first folder and the subfolders are neither all synchronized nor all unsynchronized.

11. The method of claim 1, further comprising:
if the user enables the first synchronization state, assigning synchronization states of all subfolders of the first folder as synchronized.

12. The method of claim 1, further comprising:
if the user enables the first synchronization state, and if all subfolders of the second folder are synchronized, assigning the second synchronization state as synchronized.

13. The method of claim 1, further comprising:
in response to the selection, if not all subfolders of the second folder are all synchronized or all unsynchronized, assigning the second synchronization state as partially synchronized.

14. The method of claim 1, further comprising:
if the user disables the first synchronization state, assigning synchronization states of all subfolders of the first folder as unsynchronized.

15. The method of claim 1, further comprising:
if the user disables the first synchronization state, and if all subfolders of the second folder are unsynchronized, assigning the second synchronization state as unsynchronized.

16. The method of claim 3, the method further comprising:
creating the first folder in the workspace.

17. The method of claim 16, wherein the determining comprises:
assigning the first synchronization state as synchronized if the second synchronization state is synchronized.

18. The method of claim 17, wherein the determining further comprises:
assigning the first synchronization state as unsynchronized if the second synchronization state is not synchronized.

19. The method of claim 3, the method further comprising:
moving the first folder into a third folder in the workspace, the third folder having a third synchronization state.

20. The method of claim 19, wherein the determining comprises:
assigning the first synchronization state as synchronized if the third synchronization state is synchronized; and
maintaining the first synchronization state as is if the third synchronization state is not synchronized.

21. The method of claim 20, wherein the determining further comprises:
if the third synchronization state is unsynchronized, and if the first synchronization state is not unsynchronized, assigning the third synchronization state as partially synchronized.

22. The method of claim 19, wherein the determining further comprises:
if the third folder is a root directory of the workspace, maintaining the first synchronization state as is.

23. The method of claim 1, wherein a respective folder includes files and subfolders, wherein all the files in the respective folder have same synchronization states as the respective folder, and wherein a respective subfolder has its independent synchronization state.

24. The method of claim 1, wherein all files in a root directory of the workspace have synchronization states as synchronized, and a synchronization state of the root directory is partially synchronized.

25. The method of claim 1, the method being performed on a server that hosts the environment and further comprising:
displaying, on a user interface of the server, an icon for a respective folder that distinctively indicates a synchronization state of the respective folder.

26. The method of claim 25, wherein the icon includes a first image for the state of the respective folder being synchronized, a second image for the state of the respective folder being partially synchronized, and a third image for the state of the respective folder being unsynchronized.

27. A method for selectively synchronizing folders in a workspace of a cloud-based environment, the workspace being shared among multiple users, the method comprising:
receiving from a server that hosts the environment a selection for a first synchronization state of a first folder in the workspace; and
in response to the selection, synchronizing content of the first folder on a client based on the first synchronization state regardless of a second synchronization state of a second folder in the workspace, wherein the first folder is a subfolder of the second folder.

28. The method of claim 27, further comprising:
in response to the received selection, synchronizing content of other folders in the workspace based on their respective synchronization states.

29. The method of claim 27, further comprising:
maintaining a directory tree, on the client, that corresponds to a directory structure of the first folder, wherein the directory tree on the client includes all folders having a higher hierarchy above the first folder.

30. The method of claim 29, wherein the selection includes enabling and disabling the first synchronization state, and wherein the maintaining comprises:
if the first synchronization state is enabled, and if a local folder that corresponds to the first folder does not exist, creating the local folder on the client.

31. The method of claim 29, wherein the selection includes enabling and disabling the first synchronization state, and wherein the maintaining comprises:
if (i) the first synchronization state is enabled and if the first folder is deleted in the workspace, or if (ii) the first synchronization state is disabled, deleting a local folder that corresponds to the first folder.

32. A method for synchronizing folders in a workspace of a cloud-based platform, the method comprising:
receiving, at a client on a device associated with the user, a selection from the user for a first synchronization state of a first folder on the client; and
in response to the selection, synchronizing content of the first folder with the workspace based on the first synchronization state regardless of a second synchronization state of a second folder,
wherein, the first folder is a subfolder of the second folder, and
wherein, the workspace is shared among the user and one or more collaborators of the user in the cloud-based platform.

33. The method of claim 32, further comprising:
in response to the selection, synchronizing content of other folders with the workspace based on their respective synchronization states.

34. The method of claim 32, further comprising:
maintaining a directory tree in the workspace at a server which hosts the cloud-based platform that corresponds to a directory structure of the first folder,
wherein the directory tree maintained at the server which hosts the cloud-based platform further includes folders having a higher hierarchy above the first folder.

35. The method of claim 33, wherein the selection includes enabling and disabling the first synchronization state, and wherein the maintaining comprises:
if the user enables the first synchronization state and if the first folder is deleted, communicating to a server that hosts the cloud-based platform to delete a corresponding folder in the workspace on the server that corresponds to the first folder.

36. The method of claim 34, the method further comprising:
in response to the user creating the first folder, if a folder that corresponds to the first folder does not exist in the workspace, communicating to a server that hosts the environment to create the folder that corresponds to the first folder in the workspace for synchronization.

37. The method of claim 34, the method further comprising:
in response to the user creating the first folder, if a folder that corresponds to the first folder exists in the workspace, communicating to a server that hosts the environment to create a conflicting folder in the workspace for synchronization.

38. A system for synchronizing selective folders in a workspace of a cloud-based environment, the system comprising:
a processor;
a memory having stored thereon instructions which, when executed by the processor, causes the system to:
in response to a selection, from a user, of a first synchronization state of a first folder in the workspace, synchronize content of the first folder associated with the user based on the first synchronization state regardless of a second synchronization state of a second folder in the workspace,
wherein the first folder is a subfolder of the second folder, and wherein the workspace is shared among the user and one or more collaborators of the user.

39. The system of claim 38,
wherein, in response to the selection, the system further synchronizes content of other folders in the workspace based on their respective synchronization states.

40. The system of claim 38,
wherein, before the system synchronizes the content, the first synchronization state of the first folder is determined, and wherein the first synchronization state includes one or more of: (i) synchronized, (ii) partially synchronized, or (iii) unsynchronized.

41. The system of claim 40,
wherein, the user is allowed to select the first synchronization state based on an original synchronization state of the first folder.

42. The system of claim 41, wherein:
if the original synchronization state is synchronized, the user is allowed to disable the first synchronization state to unsynchronized;
if the original synchronization state is partially synchronized, the user is allowed to either enable the first synchronization state to synchronized or to disable the first synchronization state to unsynchronized; and
if the original synchronization state is unsynchronized, the user is allowed to enable the first synchronization state to synchronized.

43. The system of claim 40, wherein:
the first synchronization state is assigned as synchronized if the content of the first folder and all subfolders of the first folder are all synchronized;
the first synchronization state is assigned as unsynchronized if the content of the first folder and the subfolders are all unsynchronized; and
the first synchronization state is assigned as partially synchronized if the content of the first folder and the subfolders are neither all synchronized nor all unsynchronized.

44. The system of claim 38, wherein:
if enables the first synchronization state, synchronization states of all subfolders of the first folder are assigned as synchronized.

45. The system of claim 38, wherein:
if the user enables the first synchronization state, and if all subfolders of the second folder are synchronized, the second synchronization state is assigned as synchronized.

46. The system of claim 38, wherein:
in response to the selection, if not all subfolders of the second folder are all synchronized or all unsynchronized, the second synchronization state is assigned as partially synchronized.

47. The system of claim 38, wherein:
if the user disables the first synchronization state, synchronization states of all subfolders of the first folder are assigned as unsynchronized.

48. The system of claim 38, wherein:
if the user disables the first synchronization state, and if all subfolders of the second folder are unsynchronized, the second synchronization state is assigned as unsynchronized.

49. The system of claim 40, wherein:
the first folder is created in the workspace;
the first synchronization state is assigned as synchronized if the second synchronization state is synchronized; and
the first synchronization state is assigned as unsynchronized if the second synchronization state is not synchronized.

50. The system of claim 40, wherein:
the first folder is moved into a third folder in the workspace, the third folder having a third synchronization state.

51. The system of claim 50, wherein:
the first synchronization state is assigned as synchronized if the third synchronization state is synchronized; and
wherein the first synchronization state is maintained as is if the third synchronization state is not synchronized.

52. The system of claim 51, wherein:
if the third synchronization state is unsynchronized, and if the first synchronization state is not unsynchronized, the third synchronization state is assigned as partially synchronized.

53. The system of claim 50, wherein:
if the third folder is a root directory of the workspace, the first synchronization state is maintained as is.

54. The system of claim 38, wherein a respective folder includes files and subfolders, wherein all the files in the respective folder have same synchronization states as the respective folder, and wherein a respective subfolder has its independent synchronization state.

55. The system of claim 38, wherein all files in a root directory of the workspace have synchronization states as synchronized, and a synchronization state of the root directory is partially synchronized.

56. The system of claim 38, wherein the system comprises a server that hosts the environment, and wherein the instructions further cause the system to:
display, on a user interface of the system, an icon for a respective folder that distinctively indicates a synchronization state of the respective folder.

57. A machine-readable storage medium having stored thereon instructions which, when executed by a processor, causes the processor to:
receive from a server that hosts a cloud-based environment a selection from the user for a first synchronization state of a first folder in a workspace of the environment; and
in response to the received selection, synchronize content of the first folder associated with the user based on the first synchronization state regardless of a second synchronization state of a second folder in the workspace,
wherein the first folder is a subfolder of the second folder, and wherein the workspace is shared among a user and one or more collaborators of the user.

58. The machine-readable storage medium of claim 57, wherein the instructions further cause the processor to:
in response to the received selection, synchronize content of other folders in the workspace based on their respective synchronization states.

59. The machine-readable storage medium of claim 57, wherein the instructions further cause the processor to:
maintain a directory tree, on a client, that corresponds to a directory structure of the first folder, wherein the directory tree on the client includes all folders having a higher hierarchy above the first folder.

60. The machine-readable storage medium of claim 59, wherein the selection includes enabling and disabling the first synchronization state, and wherein the instructions further cause the processor to:
if the user enables the first synchronization state and if a local folder that corresponds to the first folder does not exist, create, on the client, the local folder; and
if (i) the user enables the first synchronization state and if the first folder is deleted in the workspace, or if (ii) the user disables the first synchronization state, delete, from the local drive, the local folder that corresponds to the first folder.

61. A machine-readable storage medium having stored thereon instructions which, when executed by a processor, causes the processor to:
receive, at a client on a device of the user, a selection from the user for a first synchronization state of a first folder on the client; and
in response to the selection, synchronize content of the first folder with the workspace based on the first synchronization state regardless of a second synchronization state of a second folder,
wherein the first folder is a subfolder of the second folder, and wherein the workspace is shared among the user and one or more collaborators of the user.

62. The machine-readable storage medium of claim 61, wherein the instructions further cause the processor to:
in response to the selection, synchronize content of other folders with the workspace based on their respective synchronization states.

63. The machine-readable storage method of claim 61, wherein the instructions further cause the processor to:
maintain a directory tree in the workspace that corresponds to a directory structure of the first folder, wherein the directory tree in the workspace includes all folders having a higher hierarchy above the first folder.

64. The machine-readable storage method of claim 63, wherein the selection includes enabling and disabling the first synchronization state, and wherein the instructions further cause the processor to:
if the user enables the first synchronization state and if the first folder is deleted, communicate to a server that hosts the environment to delete a folder in the workspace that corresponds to the first folder.

65. The machine-readable storage method of claim 63, wherein the instructions further cause the processor to:
in response to the user creating the first folder, if a folder that corresponds to the first folder does not exist in the workspace, communicate to a server that hosts the environment to create the folder that corresponds to the first folder in the workspace for synchronization.

66. The machine-readable storage method of claim 63, wherein the instructions further cause the processor to:
in response to the user creating the first folder, if a folder that corresponds to the first folder exists in the workspace, communicate to a server that hosts the environment to create a conflicting folder in the workspace for synchronization.

67. A system, comprising:
means for synchronizing, in response to a selection of a first synchronization state of a first folder in a workspace from a user, content of the first folder based on the first synchronization state regardless of a second synchronization state of a second folder in the workspace; and
means for synchronizing, in response to the selection, content of other folders in the workspace based on their respective synchronization states;
wherein the first folder is a subfolder of the second folder, and wherein the workspace is shared among the user and one or more collaborators of the user via a server that hosts a cloud-based environment.

68. The system of claim 67, further comprising:
means for determining, before the synchronization of the first folder is performed, the first synchronization state of the first folder,
wherein the first synchronization state includes one or more of: (i) synchronized, (ii) partially synchronized, or (iii) unsynchronized.
